(19) United States
(12) Patent Application Publication
(10) Pub. No.: US 2007/0289413 A1
(43) Pub. Date: Dec. 20, 2007

(54) Swiveling driver

(76) Inventor: Andrew C. Stucky, Winchester, VA (US)

Correspondence Address: HARSHAW RESEARCH, INC., 210 W. TECUMSEH STREET, OTTAWA, KS, 66067, US

(21) Appl. No.: 11/454,023

(22) Filed: Jun. 15, 2006

(51) Int. Cl. B25B 13/46; B25B 23/16

(52) U.S. Cl. 81/60; 81/177.9

(57) ABSTRACT

A swiveling driver includes a handle portion and a head portion operatively coupled to the handle portion for selectively pivoting relative thereto. The head portion includes an implement and defines at least one detent. A yolk extends from the handle portion and includes a protrusion for selective engagement with the detent. The yolk is movable between a locked configuration in which the protrusion is received in a detent and a released configuration in which the protrusion is not received in a detent. The head portion may be moved freely when the yolk is at the released configuration for setting the angle of the head portion relative to the handle or be fixed at the locked configuration. When the head portion is fixed, the implement may be operated with either a driver bit or in a ratcheting motion.

### BACKGROUND OF THE INVENTION

This invention relates generally to hand tools and, more particularly to a swiveling driver having a head that both pivots and swivels for positioning a driver to engage a fastener and for selectively rotating a fastener with sockets or to turn a screw.

Fasteners such as bolts are frequently tightened and loosened using an implement which surrounds and grips an end of the fastener and rotates it in clockwise or counterclockwise directions to tighten or loosen the fastener, respectively. The implement described above is commonly a wrench or a ratchet wrench utilizing an appropriately sized socket to surround and grip the fastener. The ratchet mechanism enables repeated rotations to be made without continually turning a socket and then lifting and repositioning it. A socket wrench having a ratcheting mechanism may be repeatedly rotated both clockwise and counterclockwise but causing the fastener to actually be rotated in only one direction. A significant difficulty, however, is that a fastener may be situated at an odd angle such that getting and keep a wrench on the fastener is difficult.

Fasteners such as screws, however, usually include a head that may be rotated using a driver tool such as a screwdriver. Using a screwdriver or a driver bit enables this type of fastener to be initially installed and later adjusted very efficiently. A driver bit usually includes a tip that is complementary to the head of the fastener.

While both of these tools (a ratchet wrench and a screwdriver) are known in the art and effective for their intended purposes, it would be desirable to have a swiveling driver that may be selectively utilized to drive a fastener. Further, it would be desirable to have a swiveling driver having a head that selectively swivels and pivots relative to a handle for positioning the head in relation to a fastener. Further, it would be desirable to have a swiveling driver in which the head may be fixed in a plurality of positions and utilized selectively with a ratcheting or drive bit implement for manipulating a fastener.

### SUMMARY OF THE INVENTION

Accordingly, a swiveling driver according to the present invention includes a handle portion and a head portion pivotally coupled to the handle portion. The head portion may be selectively pivoted to a desired position relative to the handle. The head portion includes a generally flat face and includes an implement extending therefrom. The implement may itself be a screwdriver or may have a configuration capable of coupling to another implement accessory such as a socket or other driver bit. The implement includes a ratchet assembly The head includes a rounded portion extending rearward from the flat face, the rounded portion defining at least one detent.

The swiveling driver includes a yolk extending from an end of the handle portion and including a protrusion having a configuration complementary to that of the at least one detent for being selectively received therein. The head is movable relative to the yolk between a release configuration in which the protrusion is not received in the detent and a lock configuration in which the protrusion is received in the detent. This enables the head portion to be releasably held at a fixed position or, selectively, to enable the head portion to swivel with a wide range of motion such as a ratcheting motion. A switch is utilized to regulate the head between locked and released configurations.

In use, the head portion may be released to move freely so as to move to a desired angle relative to the handle portion. Then the head portion may be fixed at a desired angle relative to a fastener. Then, an implement such as a screwdriver bit may be utilized as the implement to rotate a fastener such as a screw. Or, the implement may be coupled to a ratchet accessory and used for a ratcheting motion.

Therefore, a general object of this invention is to provide a swiveling driver for rotating a fastener.

Another object of this invention is to provide a swiveling driver, as aforesaid, having a head that selectively pivots for positioning a head at a desired position for properly addressing the fastener.

Still another object of this invention is to provide a swiveling driver, as aforesaid, having a head that selectively swivels for positioning a head at a desired position for properly addressing the fastener.

Yet another object of this invention is to provide a swiveling driver, as aforesaid, having an implement that is a screwdriver or that may be coupled to a screwdriver or other driver bit.

A further object of this invention is to provide a swiveling driver, as aforesaid, having an implement that may be coupled to a socket.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a swiveling driver according to a preferred embodiment of the present invention;

FIG. 2a is a rear view of the swiveling driver as in FIG. 1 with a head portion in a front facing configuration;

FIG. 2b is a side view of the swiveling driver as in FIG. 2a;

FIG. 2c is a sectional view taken along line 2c-2c of FIG. 2a;

FIG. 3a is a rear view of the swiveling driver as in FIG. 1 with the head portion in an upward facing configuration;

FIG. 3b is a side view of the swiveling driver as in FIG. 3a;

FIG. 4a is a perspective view of the yolk as in FIG. 1 removed from the handle portion and illustrating the head portion and yolk at a lock configuration;

FIG. 4b is another perspective view as in FIG. 4a with the head portion and yolk at a release configuration;

FIG. 5 is a top view of a case having a plurality of elements shown with a lid in an open configuration;

FIG. 6a is a side view of the case as in FIG. 5 with the lid in a closed configuration;

FIG. 6b is a rear perspective view of the case as in FIG. 6a;

FIG. 6c is a bottom view of the case as in FIG. 6a; and

FIG. 6d is a front view of the case as in FIG. 6a.

### DESCRIPTION OF THE PREFERRED EMBODIMENT

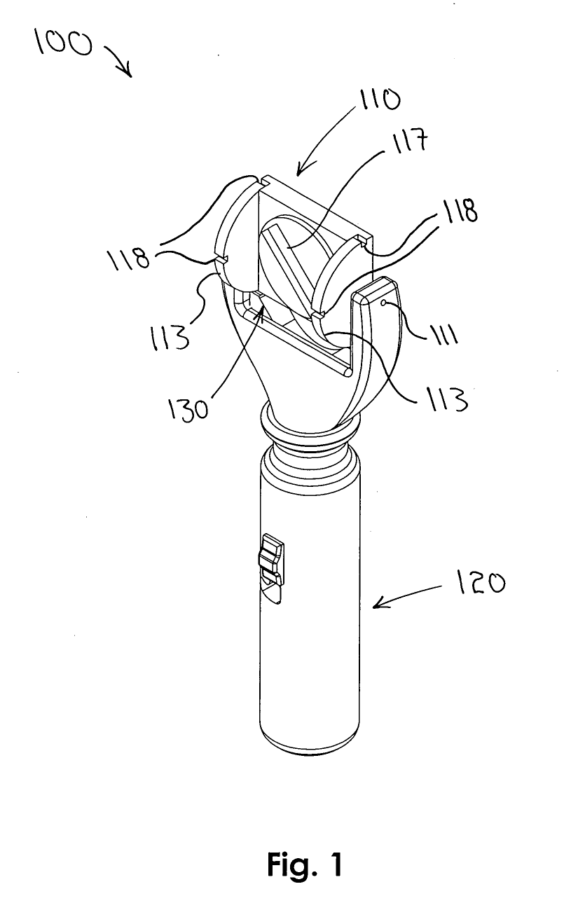

A swiveling driver 100 according to the present invention will now be described in detail with reference to FIGS. 1a through 6d of the accompanying drawings. More particularly, a swiveling driver 100 according to the current invention includes a head portion 110 and a handle portion 120.

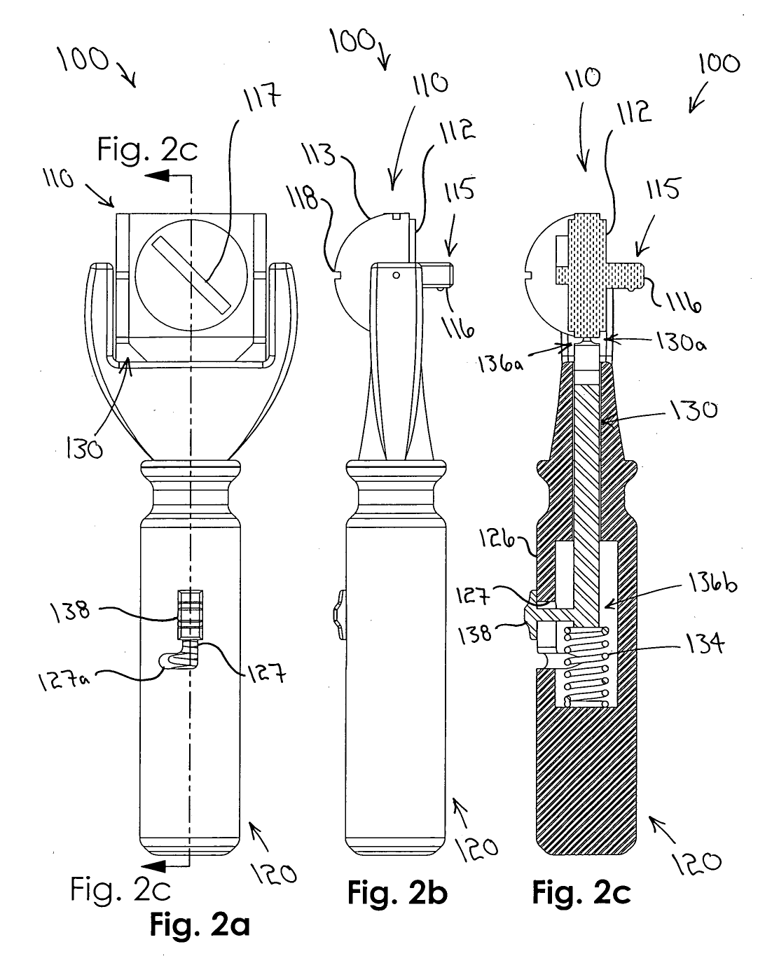

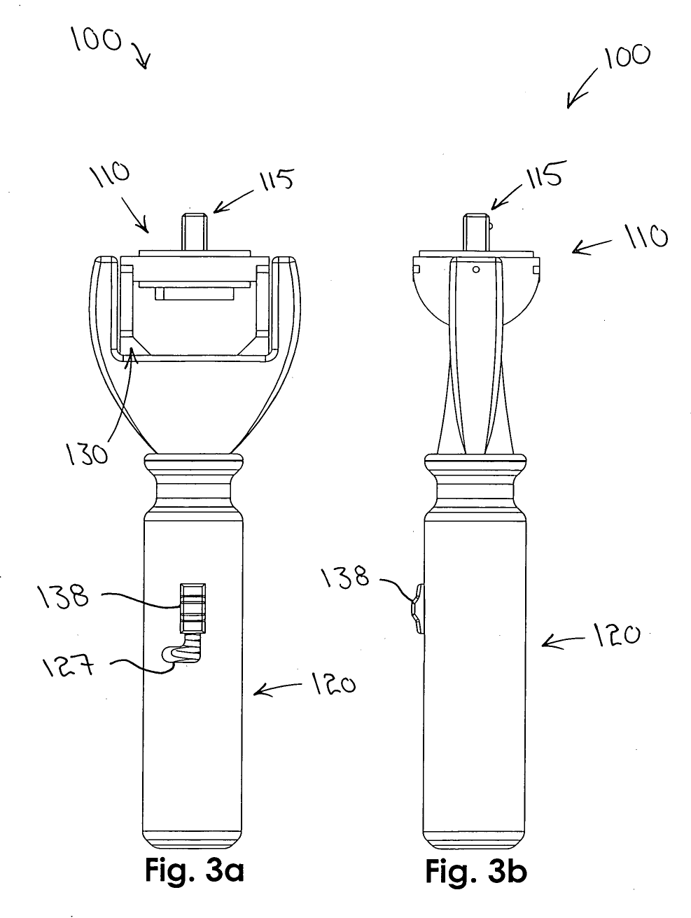

The head portion 110 is operatively coupled to the handle portion 120 for selective pivoting or rotation relative to the handle portion 120 (i.e., by pins 111 shown in FIG. 1a). The head portion 110 has an implement 115 (FIGS. 2b through 3b) and at least one detent 118 (shown throughout the drawings). The implement 115 may be a ratcheting implement 115 (as shown in the drawings,) and may be driver bit 116 or a screwdriver bit, for example. The driver bit 116 may present a male configuration (as shown) or a female configuration, and may, for example, receive or otherwise couple a socket, screwdriver bit, etc. to the head portion 110.

The head portion 110 may have a substantially planar face surface 112. A rounded outer surface 113 may extend from the face surface 112 and define the detent(s) 118. The implement 115 may extend from the face surface 112 opposite the rounded outer surface 113, as shown in FIG. 2b for example. The ratcheting implement 115 may have a ratchet selection member 117 that allows a user to select a ratcheting configuration (e.g., clockwise, counterclockwise), and the ratchet selection member 117 may be accessible adjacent the rounded outer surface 113 (FIG. 1a).

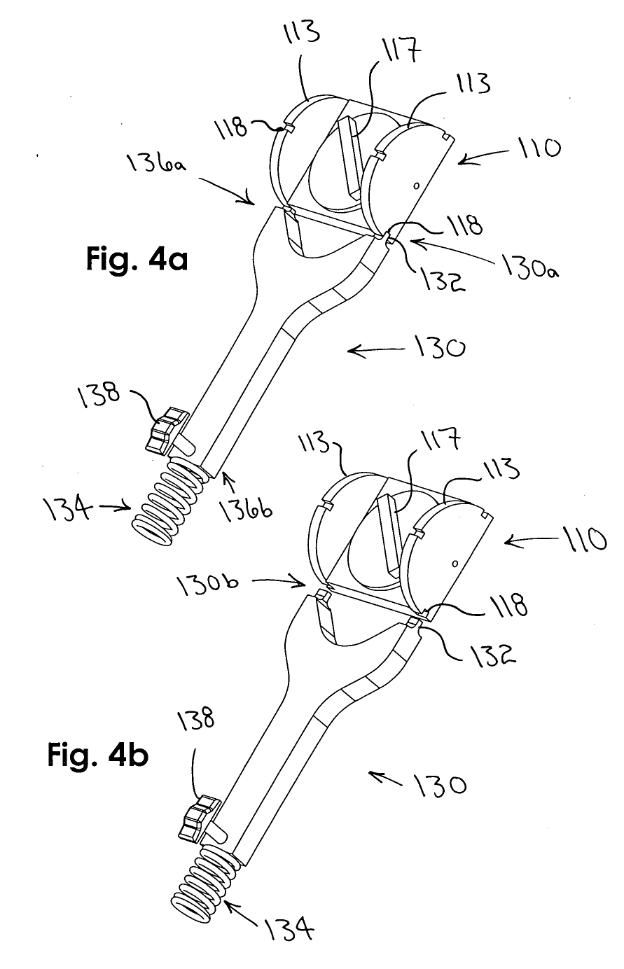

Means for selectively maintaining the head portion 110 in a fixed position relative to the handle portion 120 may be included. More particularly, a yolk 130 may extend from the handle portion 120 (FIG. 2c). As shown in FIGS. 4a and 4b, the yolk 130 may have a protrusion 132 complementary to the detent(s) 118 defined by the head portion 120, and the yolk 130 may be movable between a release configuration 130b (FIG. 4b) in which the protrusion 132 is not receivable in the detent(s) 118 and a lock configuration 130a (FIG. 4a) in which the protrusion 132 is receivable in the detent(s) 118. If a plurality of detents 118 are included, the yolk 130 may selectively maintain the head portion 110 in a plurality of fixed positions relative to the handle portion 120.

As best shown in FIG. 2c, a spring 134 may bias the yolk 130 toward the lock configuration 130a. The handle portion 120 may have a sidewall 126 defining a switch opening 127, and the yolk 130 may have first and second ends 136a, 136b. The protrusion 132 may be adjacent the first end 136a of the yolk 130, and the second end 136b of the yolk 130 may extend into the handle portion 120. A switch 138 may extend from the yolk second end 136b through the switch opening 127 for moving the yolk 130 between the release configuration 130b and the lock configuration 130a. As shown in FIG. 2a, the switch opening 127 may have an offset portion 127a, and the switch 138 may maintain the yolk 130 at the release configuration 130b when the switch 138 is at the offset portion 127a of the switch opening 127.

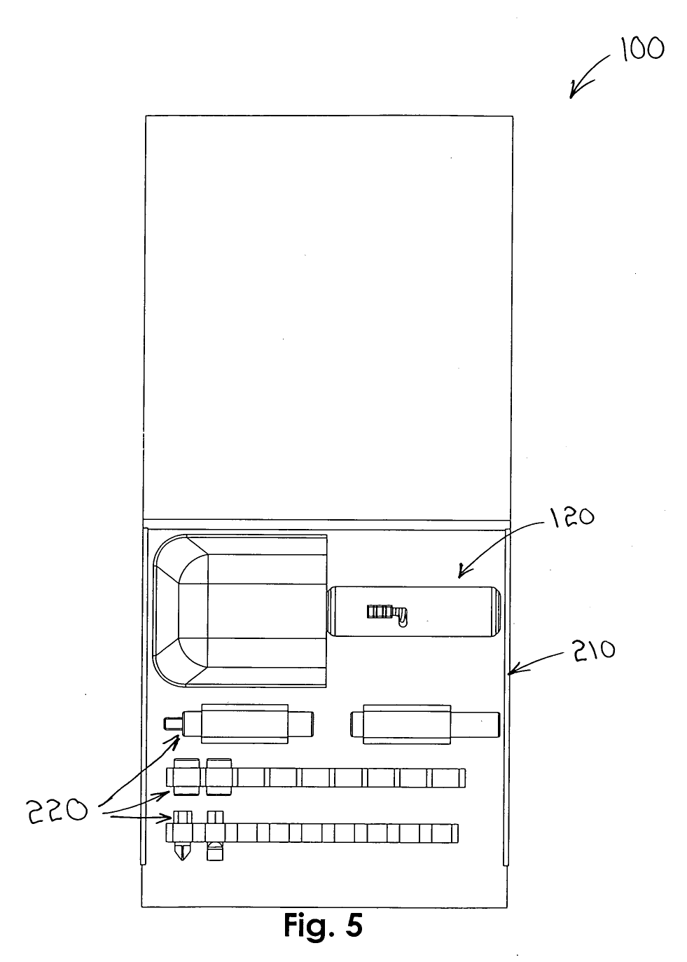

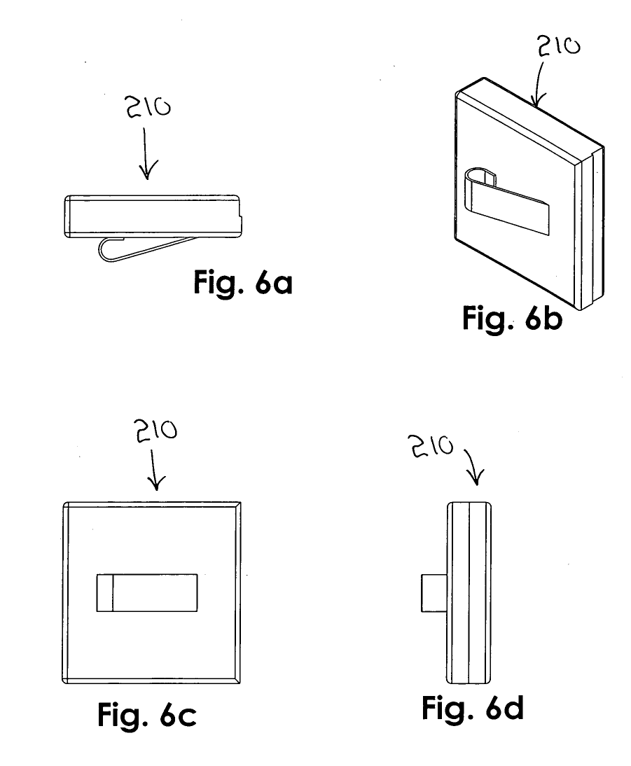

FIGS. 5 through 6d show that the driver 100 may further include a case 210 and a plurality of elements 220 complementary to the ratcheting implement 115, such as sockets, screwdriver bits, bit adapters, and extensions. The case 210 may have means for securing the head portion 110, the handle portion 120, and/or the complementary elements 220, such as pockets, indentations, or straps. The case 210 may also have a belt clip 212 for removably securing the case to a user's belt.

In use, the user may move the yolk 130 to the lock configuration 130a (FIG. 4a) or the release configuration 130b (FIG. 4b) using the switch 138. To move the yolk 130 to the lock configuration 130a, the switch 138 may be removed from the offset portion 127a of the switch opening 127, and the spring 134 may bias the yolk 130 toward the head portion 110. The protrusion 132 may mate with a detent 118 when the yolk 130 is so biased to fix the position of the head portion 110 relative to the handle portion 120. Depending on the placement of the detent(s) 118, the user may move the yolk 130 to the lock configuration 130a so that the implement 115 is parallel to the handle portion 120 (FIGS. 3a and 3b) or so that the implement 115 is perpendicular to the handle portion 120 (FIG. 2c). If the implement 115 is a ratcheting implement, the ratchet selection member 117 may be adjusted to select a ratcheting configuration as discussed above. The complementary elements 220 may be coupled to the implement 115 as discussed above.

To allow the head portion 110 to swivel relative to the handle portion 120, the yolk 130 may be moved to the release configuration 130b by moving the switch 138 to the offset portion 127a of the switch opening 127, effectively compressing the spring 134. While the yolk 130 is at the release configuration 130b, a large range of motion is provided for the user; implement 115 may allow ratcheting motion and the head portion 110 may be swiveled relative to the handle portion 120. The case 210 may be used for storage and organization.

It is understood that while certain forms of this invention have been illustrated and described, it is not limited thereto except insofar as such limitations are included in the following claims and allowable functional equivalents thereof.

What is claimed is as follows:

1. A swiveling driver, comprising:
a handle portion;
a head portion operatively coupled to said handle portion for selective pivoting relative to said handle portion, said head portion having an implement and a detent; and
a yoke extending from said handle portion, said yoke having a protrusion complementary to said detent for selectively maintaining said head portion in a fixed position relative to said handle portion.

2. The driver of claim 1, wherein said head portion includes an outer surface defining said detent.

3. The driver of claim 2, wherein said head portion has a plurality of detents complementary to said yoke protrusion for selectively maintaining said head portion in a plurality of fixed positions relative to said handle portion.

4. The driver of claim 2, wherein said head portion outer surface is generally rounded.

5. The driver of claim 1, wherein said implement is a ratcheting implement.

6. The driver of claim 1, wherein said implement is selected from the group consisting of a screwdriver bit and a driver bit.

7. The driver of claim 1, wherein said yoke is movable between a release configuration in which said protrusion is not receivable in said detent and a lock configuration in which said protrusion is receivable in said detent.

8. The driver of claim 7, wherein a spring biases said yoke toward said lock configuration.

9. The driver of claim 8, wherein:
said handle portion has a sidewall defining a switch opening;
said yoke has first and second ends;
said protrusion is adjacent said yoke first end;
said yoke second end extends into said handle portion; and
a switch extends from said yoke second end through said switch opening for moving said yoke between said release configuration and said lock configuration.

10. The driver of claim 9, wherein:
said switch opening has an offset portion; and
said switch maintains said yoke at said release configuration when said switch is at said offset portion of said switch opening.

11. The driver of claim 10, wherein said implement is a ratcheting implement.

12. The driver of claim 11, wherein said ratcheting implement is selected from the group consisting of a screwdriver bit and a driver bit.

13. The driver of claim 1, wherein:
said head portion has a substantially planar face surface;
a rounded outer surface defines said detent and extends opposite from said face surface; and
said implement extends from said face surface opposite said rounded outer surface.

14. The driver of claim 13, wherein:
said implement is a ratcheting implement having a ratchet selection member; and
said ratchet selection member is accessible adjacent said rounded outer surface.

15. A swiveling driver, comprising:
a handle portion;
a head portion operatively coupled to said handle portion for selective rotation relative to said handle portion, said head portion having a ratcheting implement; and
means for selectively maintaining said head portion in a fixed position relative to said handle portion.

16. The driver of claim 15, wherein said means for selectively maintaining includes a yoke extending from said handle portion, said yoke having a protrusion complementary to at least one detent defined by said head portion.

17. The driver of claim 16, wherein:
said yoke is movable between a release configuration in which said protrusion is not receivable in said at least one detent and a lock configuration in which said protrusion is receivable in said at least one detent;
a spring biases said yoke toward said lock configuration;
said handle portion has a sidewall defining a switch opening;
said yoke has first and second ends;
said protrusion is adjacent said yoke first end;
said yoke second end extends into said handle portion; and
a switch extends from said yoke second end through said switch opening for moving said yoke between said release configuration and said lock configuration.

18. A swiveling driver, comprising:
a handle portion;
a head portion operatively coupled to said handle portion for selective rotation relative to said handle portion, said head portion having a ratcheting implement and a detent;
a yoke extending from said handle portion, said yoke having a protrusion complementary to said detent for selectively maintaining said head portion in a fixed position relative to said handle portion;
a plurality of elements complementary to said ratcheting implement, at least one said element being selected from the group consisting of sockets, screwdriver bits, bit adapters, and extensions; and
a case having means for securing at least one item selected from the group consisting of said handle portion, said head portion, and said plurality of elements thereto.

19. The driver of claim 18, wherein:
said yoke is movable between a release configuration in which said protrusion is not receivable in said detent and a lock configuration in which said protrusion is receivable in said detent;
a spring biases said yoke toward said lock configuration;
said handle portion has a sidewall defining a switch opening;
said yoke has first and second ends;
said protrusion is adjacent said yoke first end;
said yoke second end extends into said handle portion; and
a switch extends from said yoke second end through said switch opening for moving said yoke between said release configuration and said lock configuration.

20. The driver of claim 19, wherein:
said head portion has a substantially planar face surface;
a rounded outer surface defines said detent and extends from said face surface;
said ratcheting implement extends from said face surface opposite said rounded outer surface and has a ratchet selection member; and
said ratchet selection member is accessible adjacent said rounded outer surface.
